(19) United States
(12) Patent Application Publication
(10) Pub. No.: US 2012/0023034 A1
(43) Pub. Date: Jan. 26, 2012

(54) Store Mapping System and Method for Locating Merchandise in a Store

(76) Inventors: Nancy Lynch, Fresno, CA (US); Michael Wayne Lynch, Fresno, CA (US)

(21) Appl. No.: 12/842,681

(22) Filed: Jul. 23, 2010

(51) Int. Cl. G06Q 30/00; G06F 17/30

(52) U.S. Cl. 705/346; 707/705; 707/E17.107

(57) ABSTRACT

A system and method for locating merchandise in a store having a plurality of products, such as grocery stores and the like. Each product in the store is assigned identifying information, including a location indicator, position indicator and shelf zone indicator, that is associated with the store layout and which can be utilized by a customer to locate a single item in the store. The identifying information for each product is entered into a computerized database, which includes product availability information. Access to the database is provided to customers through computer terminals in the store and via the Internet from a computer or other device. The customer can also access the database using a hand-held device, such as a smart phone or PDA, and use the device as he or she obtains the item. Using the identifying information, the customer can easily and quickly find the item in the store.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

### A. Field of the Invention

The field of the present invention relates generally to methods and systems used for identifying the location of an item in a store, including grocery stores, electronics stores and the like. More particularly, the present invention relates to such methods and systems which a customer can utilize to quickly identify the location of particular merchandise in a store so that he or she may efficiently locate and purchase the item. Even more particularly, the present invention relates to such methods and systems that cooperate with a mobile telephone or other electronic device to locate the merchandise.

### B. Background

Most modern retail stores, including stores selling merchandise such as groceries, electronics, books and other retail products, place the items for sale on racks or other display apparatuses disposed in rows located throughout the store. In fact, larger stores generally have many such rows of racks, with most of the rows being quite long and each having a plurality of shelves thereon that are configured to display many different products. Grocery stores also have enclosed display apparatuses that are configured to keep the food, drink or other items therein in a cold or frozen condition. The rows of racks in a store are typically configured to allow the customer to move along the rows, often with a cart or basket, to locate and then remove the desired merchandise from the shelf. The customer then takes the merchandise to a cashier or other checkout person to pay for his or her purchase.

In a large retail store there can be many thousands of items that are offered for sale. Generally, at any one time the customer is only interested in purchasing a very small percentage of the items that are available in the store. In fact, it is not uncommon for a customer to desire to purchase only a few different items. In some circumstances, the customer may only desire to purchase a single item. Even when the customer desires to purchase many items, such as a trip to the grocery store to purchase a week's worth of groceries, the number of items of interest to the customer usually only represents a small fraction of the number of items available in the store. When the customer enters the store, he or she has to locate the item or items of interest in the store. Depending on the layout of the store and the customer's familiarity with the store, locating items in a store, particularly a large store having many different types of items (such as a grocery store or the like), can be difficult and time consuming. The difficultly and time associated with locating a particular item or items in a store can cause some people to avoid going to certain stores when he or she only desires to obtain one item or only a few items. If possible, the customer may choose to do without the item or items for the time being or go instead to a much smaller store, such as a convenience store or the like, to obtain the item(s). Although convenience-type stores often charge more money for the same item compared to larger stores, which is particularly true with regard to grocery items, many people would rather pay more for the item than take the time to navigate the many rows of products in the larger store when he or she only needs one or a few items.

To assist the customer with locating the items that of are interest to him or her, most stores group related items on the same row and generally near each other on the shelves of the row. One problem with attempting to group items together is deciding which items are related in a manner that the customer easily and rationally associates the items together. For instance, depending on the specific product, a particular grocery store manager may group canned goods with other canned goods, with related food products although they are not canned (e.g., cans of refried beans with bags of tortilla chips or cans of juices with bottles of juices), with canned goods of the same general type (e.g., cans of vegetables together) or in a variety of other different combinations. Other store managers, even for the same chain of stores, may decide to group “related” items together in a different manner. In a grocery store, the ability to group particular related items together is further complicated by the fact that some items may be related but they need to be refrigerated or frozen, which requires the item to be placed in a different location than the related non-refrigerated or non-frozen items. Although the customer's interest is generally considered paramount, the grouping of items together on the same shelves and racks in a store may also be dictated by the ease by which those items may be restocked by store employees and/or various product representatives.

To further assist the customer with locating items in a store, most stores utilize overhead banners or signs between the rows of racks that are intended to at least generally describe the items on the shelves along that row. Naturally, the usefulness of a banner or sign to identify what is on that row is somewhat limited due to the space available on the banner or sign relative to the potential number of different items that may be on the shelves. Many stores also have identifying information on the racks and/or the shelves that can be used to locate items. Unfortunately, most such identifying information is in the form of labels affixed to or supported by the shelves below or above the product, which means the customer must already be in the general vicinity of the desired item, if not right in front of the item, in order for the identifying information to be of any use. Many stores require their employees to assist customers with locating products in a store, particularly those customers who appear “lost” in the store. Generally, retail stores do not have employees who are specifically designated to assist customers with locating items in the store. As a result, an employee who is assisting a customer with locating a product has had to leave his or her normal duties, which may result in those duties not being performed in a timely fashion. Some stores require the employee to lead the customer directly to the desired item, which some customers find annoying. The usual scenario, however, is that the customer typically has difficulty locating an employee who is available and/or knowledgeable with regard to locating the item the customer desires, which only further frustrates the customer and results in additional lost time related to finding the item he or she needs.

An additional problem with locating an item in a store having many thousands of items is that it is not uncommon for store managers and others to rearrange the items in the store and/or redecorate the store in a manner that changes the location of the items. As a result, even a customer who is generally familiar with the layout of a store (it is unlikely that any customer would know where every item is) can have difficulty in locating an item that has been moved from one location to another in the store. Another problem with locating an item in a store is that the item may be temporarily unavailable (i.e., sold out) or it may no longer be available in the store because the store manager or others may have made the decision to discontinue carrying the item. Naturally, when a customer enters the store he or she has no way of knowing if the item is not available because it is out of stock or discontinued.

Most modern stores utilize relatively sophisticated computerized systems to track inventory, determine product prices and other pertinent product information for every item in the store. The development of the Universal Product Code (“UPC”) markings or codes for products and modern computer systems have facilitated the improved ability of the store managers to track and quantify information pertaining to the merchandise on the shelves of the store. When a customer removes merchandise from the shelf of a retail store and takes it to the checkout area of the store, the clerk will scan the product to obtain the price of the product and any current promotional incentives associated with the product (e.g., price discounts, two-for-one specials and etc.). The sale of the item is then transmitted to a central computer where the inventory of that product is adjusted accordingly. Based on information relating to the sale of an item, and in some circumstances to the non-sale of an item (i.e., the item remaining on the shelf), the management of the store can make decisions regarding the product, such as the quantity and timing of future wholesale purchases of the item and whether it is necessary to lower the price of any remaining items in inventory to better sell the product.

As well known by customers and those in the industry, a unique UPC mark is placed on virtually every item in the store to identify the item when it is scanned with a portable scan gun or by a mounted scanner located at or near the checkout counter. The typical scanner reads the UPC code on the item to retrieve the stored information regarding the item. Depending on what information is stored in the computer and desired to be available to employees and/or customers, the information which can be retrieved by the scanning device includes the standard retail price, any price or sale specials, cost of the item, inventory on hand and a description of the item. In addition to being useful to the store when a customer is purchasing the item, the information is also useful for employees and contractors doing inventory. Although some stores have scan devices at or near the ends of some rows to provide price information for an item, these devices are not useful to the customer for locating an item in the store.

Some stores, particularly bookstores, have computerized systems that are intended to assist the customer with locating an item in the store. The typical search system comprises one or more computer terminals at one or more fixed locations in the store that has a search engine program that allows the customer to type in part or all of a title, author, keyword or other identifying information about the desired book. Upon finding the book, the screen displays the availability of the book and the category classification associated with the book by the store (i.e., whether it is in travel, history, fiction or etc.). With this information, the customer must then locate the relevant category in the store, which are typically identified by overhead banners and/or signs, and then attempt to locate the book in the shelves that are associated with that category. For some titles, the book is associated with a sub-category. These systems do not identify in a specific manner on which row, which rack or which shelf the book is located. The customer often must still wander around the store looking for the category and/or obtain assistance from a store employee.

What is needed, therefore, is an improved system and method for assisting a customer with locating merchandise in a store. Such an improved system and method should be configured to assist a customer with quickly and efficiently locating a particular item or a group of items, whether related to each other or not, in a store having many different products in the store. The system and method should be configured to identify which rack in a plurality of racks has the item and at least approximately where on the rack, such as the shelf location of the rack, the item is located. The preferred system and method of locating items in a store should include a computerized database that is accessible to a customer so he or she can access the database and locate the item before having to search for the item in the store. The system and method should include a printer so the customer can printout a map of the store showing where in the store the sought-after items can be found. Preferably, the store's database should also accessible at more than one location in the store so the customer can check or recheck the location of an item as necessary while shopping in the store. To further assist the customer with locating items in a store, the system and method should be configured to allow the customer to access the location database from a hand-held device, such as a cellular phone, PDA or the like that is carried by the customer and/or from a computer at his or her home, business or other location so that he or she may use the device or computer to locate the product. Preferably, the system and method should also be configured to let the customer know whether the item he or she wants is available in the store. In a preferred embodiment, the system and method should assist the store with better organizing the various products in the store. The system and method should be configured so as to be adaptable to a variety of different types of stores selling different types of items.

### SUMMARY OF THE INVENTION

The store mapping system and method of the present invention solves the problems and provides the benefits identified above. That is to say, the present invention discloses a new and improved system and method to assist customers with locating merchandise in a store. The system and method allows a customer to quickly and efficiently locate one or more items in a store having many different items, even thousands of different items. The system and method of the present invention is useful for identifying the particular shelf location of an item located amongst a plurality of racks disposed in rows with each rack having more than one shelf. The system and method of the present invention is also utilized in stores that have shelf racks that are not placed in rows and in stores that utilize other display apparatuses or the floor to display items that need to be located by a customer. The present system and method of locating items in a store utilizes a computerized database of the location of all of the products in the store that is accessible to a customer so that he or she may access the database to find his or her desired item or items. In one embodiment, the customer will access the database through a terminal located at or near the entrance of the store so he or she may locate the item before having to search for the item in the store. The system and method of the present invention also allows the customer to access the database from other locations in the store so the customer can check or recheck the location of an item as necessary while shopping in the store. Preferably, the system and method includes a printer to allow the user to print a map showing the location of his or her desired item or items in the store. In one embodiment, the system and method of the present invention also allows the customer to access the location database from a hand-held device, such as the customer's cellular phone, PDA or the like that is carried by the customer, from a device supplied by the store and/or from a computer located at the customer's home, business or other location so that he or she may use the device and/or computer to locate the product. The preferred system and method will inform the customer whether the item he or she wants is in stock in the store, out of stock or discontinued. Stores utilizing the system and method of the present invention will be able to be better organized, thereby improving efficiency for the customer and the store. The system and method is readily adaptable to a wide variety of different types of stores selling different types of items.

In one general aspect of the present invention, the system is utilized for locating an item in a store that has a plurality of products therein, with one of the products defining an item being sought by a customer. The system generally comprises one or more racks or other display apparatuses in the store, a store layout associated with the store and each of the racks, identifying information associated with each of the products, including the item being sought by the customer, that identifies the location of each of the products relative to the store layout, a store database storing the identifying information and a means utilized by the customer for accessing the store database. Each rack has one or more shelves that are configured to display the products, including the item, thereon. The shelves define one or more shelf zones, with the products and the item being disposed in the shelf zones. The identifying information comprises a location indicator that is associated with each of the racks, a position indicator associated with the linear position of the products on the rack and the one of the shelf zones. In a preferred embodiment, the accessing means utilized by the customer to find the item comprises at least one computer terminal located in the store, usually near the front of the store. Typically, the computer terminal will have one or more peripheral devices, such as a screen, printer and/or speaker, connected thereto that the customer can utilize to locate the item he or she is seeking. Depending on the peripheral device, the customer can see, print and/or hear the identifying information for the item. In a preferred embodiment, the system is configured to allow the customer to use his or her own device, which may be a hand-held device such as a cellular telephone (particularly the “smart” phones), PDA or the like or a computing device such as a laptop or desktop computer. The customer can use the hand-held device in the store to access the database through a wireless connection to the computer terminal, to another computing system in the store or the Internet. Preferably, the customer can transfer location information associated with the item and, if desired, the store layout to his or her hand-held device. The customer can use the computing device from his or her home, office or other location (e.g., library, coffee shops and the like having Internet access) to connect to the database via the Internet prior to going to the store.

The method of the present invention is utilized to locate an item sought by a customer in a store having a plurality of products, including the item as one of the products, disposed on one or more display apparatuses. In a preferred embodiment, the method comprises the steps of assigning each product (including the item) identifying information that identifies the location of the products in the store, entering the identifying information for each product into a store database, providing the customer with access to the store database, the customer accessing the store database to obtain the identifying information for the item and then locating the item in the store using the identifying information in light of the store layout. As set forth above, in one embodiment, the display apparatuses are racks having shelves that define one or more shelf zones and the identifying information comprises a location indicator associated with each of the racks, a position indicator associated with the position of the products on the rack and one of the shelf zones. In the preferred embodiment, the accessing step is accomplished by a computer terminal located in the store and/or by use of a customer device utilized by the customer. As set forth above, the customer device can be a hand-held device or a computing device. The hand-held device can wirelessly interact with the computer terminal or another computer system in the store to access the store database and obtain the identifying information for the item. Alternatively, the customer can access the store database through the Internet using the hand-held device and/or a computing device, such as a laptop or desktop computer.

Accordingly, the primary objective of the present invention is to provide a store mapping system and method for locating merchandise in a store that provides the advantages discussed above and overcomes the disadvantages and limitations associated with presently available systems and methods for locating items in a store.

It is also an important object of the present invention to provide a system and method for locating items in a store that allows a customer to quickly and efficiently determine the specific location of an item in a store so that he or she may locate the item for purchase.

It is also an important object of the present invention to provide a system and method for locating items in a store that specifically identifies the location of an item in a store having many different types of products located on racks, shelves or other display apparatuses located throughout the store.

It is also an important object of the present invention to provide a system and method for locating items in a store that can be utilized with the customer's cellular telephone, PDA or other hand-held device or with a device supplied by the store so the customer may carry the device with him or her while shopping in the store.

It is also an important object of the present invention to provide a system and method for locating items in a store that allows the customer to print a map-like store layout showing the location of an item in the store that he or she can use to find the item.

Another important object of the present invention is to provide a system and method for locating items in a store that also informs the customer whether the product is in stock, temporarily unavailable or discontinued.

Another important object of the present invention is to provide a system and method for locating items in a store that allows a customer to more efficiently locate one or more items in a store, particularly a large store, allows a store to more efficiently and effectively utilize its employees and gives incentive to the store to better organize the layout of items in the store.

Yet another important object of the present invention is to provide a system and method for locating items in a store that is readily adaptable to a wide variety of different stores selling a wide variety of different products.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a schematic view of a store having a store layout that is utilized with the system and method of a preferred embodiment of the present invention;

FIG. 2 is a schematic view of a store having an alternative store layout that is utilized with the system and method of a preferred embodiment of the present invention;

FIG. 3 is a front view of a rack of the store layout of FIG. 1 showing a plurality of products on the shelves, including the item a customer is seeking; and

FIG. 4 is a chart summarizing the method of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, the figures and description provided herein are primarily directed to use of the system and method of the present invention with a grocery store or the like. Those skilled in the art, however, will readily understand that this is merely for purposes of simplifying the present disclosure and that the present invention is not so limited as the present system and method can be utilized with different types of stores selling different types of items.

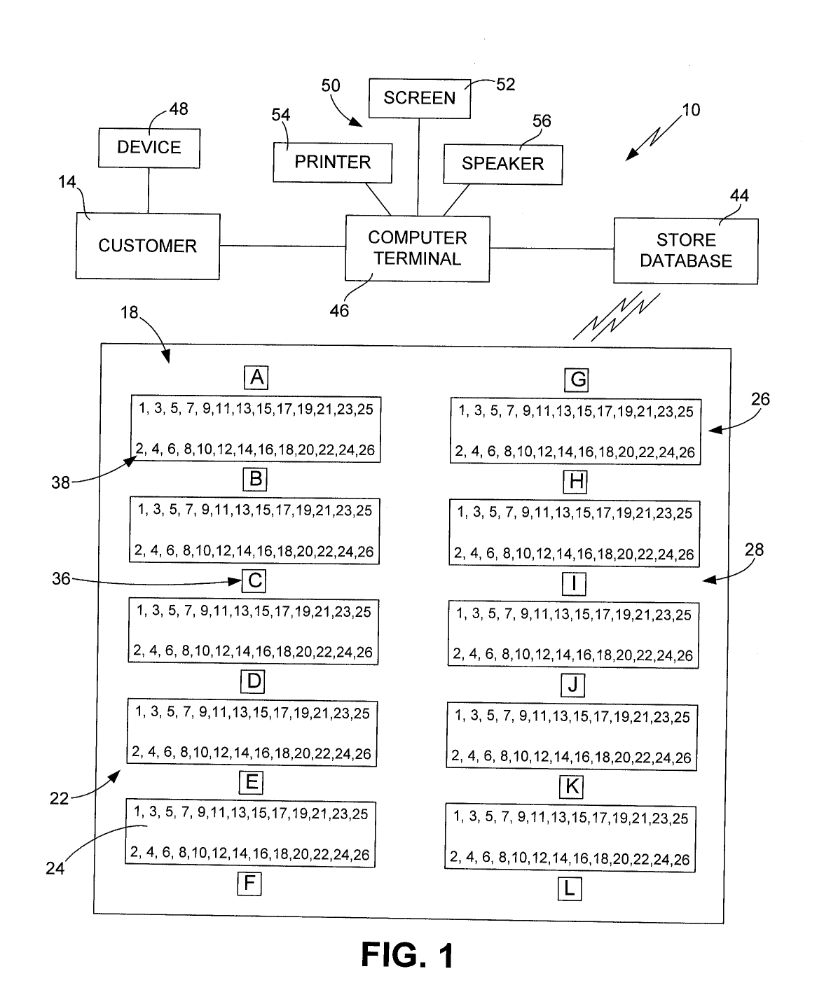

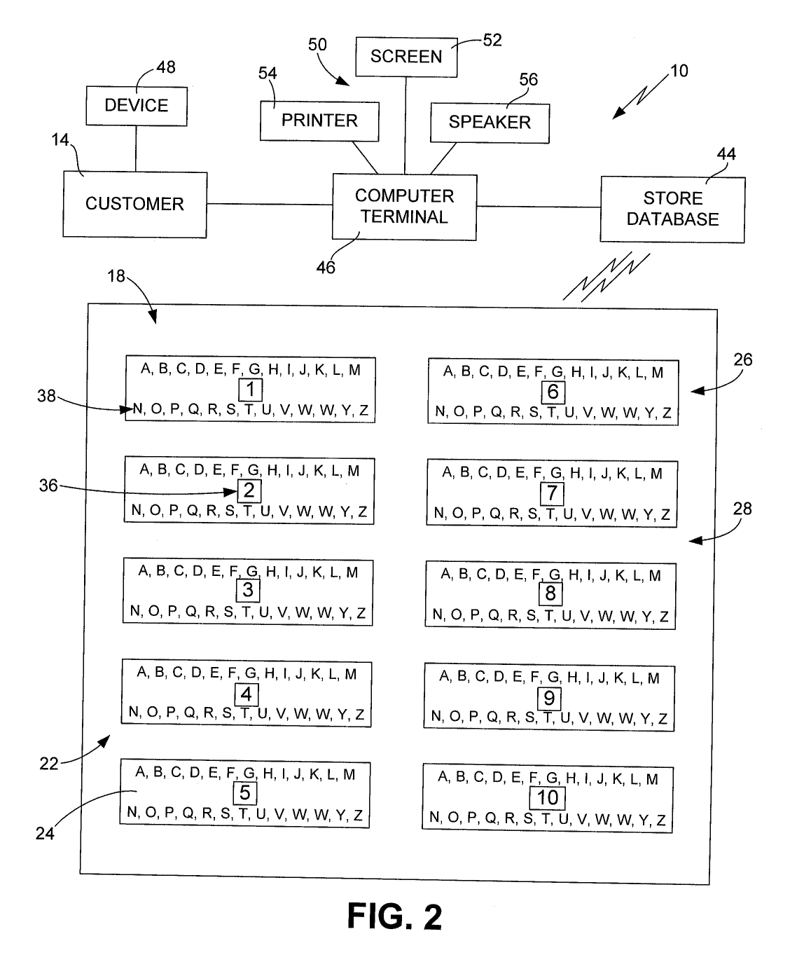

A store mapping system that comprises the components and is configured pursuant to a preferred embodiment of the present invention is shown generally as 10 in the figures. As set forth in more detail below and shown in FIGS. 1 through 4, the store mapping system 10 and method of use, shown as 12, of the present invention allows a customer 14 to quickly, easily and efficiently locate an item 16 in a store 18 having a plurality of products, shown collectively as 20, so he or she may purchase item 16 (which is one of products 20) without having to spend unnecessary time searching throughout store 18 for item 16. For purposes of describing the system 10 and method 12 of the present invention, an exemplary store 18 is shown in FIGS. 1 and 2. As will be readily appreciated by those skilled in the art, every store 18 has a store layout 22 comprising a plurality of display apparatuses, such as racks 24, positioned throughout the store 18. In the store layout 22 of FIGS. 1 and 2, the racks 24 are positioned in a plurality of rows 26 with an aisle 28 located between each row 26 of racks 24 through which the customer 14 will move as he or she shops in the store 18. While such a store layout 22 is typical for many stores 18, including grocery stores, “big box” stores, electronic stores and others, a wide variety of other store layouts 22 are also commonly utilized in the retail industry. As will be readily apparent to those skilled in the art, while the use of a specific store layout 22 is not critical to the system 10 and method 12 of the present invention, it is important that the store layout 22 of store 18 using system 10 and method 12 be known so that a specific item 16 can be located by the customer 14 relative to store layout 22. Based on store layout 22, the system 10 and method 12 will allow customer 14 locate item 16 without having to wander up and down the aisles 28 of store 18.

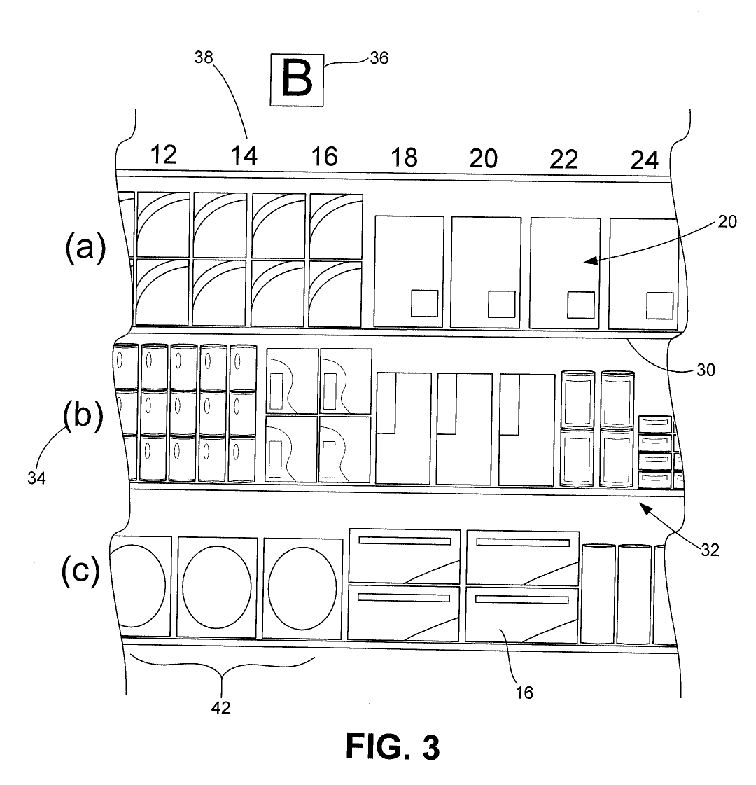

As shown in FIG. 3, the plurality of products 20 in the store 18 are displayed on racks 24, or other display apparatuses (which may be or include the floor of the store 18), in a manner that allows the customer 14 to see the products 20, including the item 16 he or she is seeking to obtain. The racks 24 have one or more shelves 30 thereon, such as the three shown in FIG. 3, configured in a shelf arrangement, shown as 32, that is identifiable and utilized with the store layout 22 of store 18 to locate item 16 in the plurality of products 20. In the configuration of the shelves 30 of FIG. 3, the shelf arrangement 32 results in three separate shelf zones 34, shown as (a), (b) and (c). As with store layout 22, although the shelf arrangement 32 can be different than that shown in FIG. 3, including significantly different, it needs to have one or more identifiable shelf zones 34 that display the plurality of products 20, including the item 16 that the customer 14 is seeking. As set forth in more detail below, the shelf zones 34 are utilized along with the store layout 22 to identify the location of item 16 to the customer 14.

Although the plurality of products 20, including item 16, on shelves 30 are stacked or otherwise arranged on the shelve 30 in a wide variety of different manners, the various like products 20 are typically grouped together by their brand or manufacturer and by type. For instance, soup cans are typically placed with other soup cans and grouped together by flavor and brand. Similar groupings are done for most other products, flavors and brands. As discussed above, the specific arrangement and grouping of products 20 are often selected by store managers, dictated by other management or otherwise selected based on an intent to achieve various benefits to customers, employees, contract persons and product distributors. The selected grouping of products 20 in a store 18 is not always conducive to locating a particular item 16 within the store 18 by the customer 14. For instance, many products that seem logical to be placed together, such as tortilla chips, refried beans, flour tortillas, hots sauce and canned jalapenos are usually not placed together due to practical reasons, such as for ease of stocking and some items may require refrigeration or freezing. In addition, grouping of one type of product together is very likely to break apart an otherwise different grouping of products, for instance tortilla chips can be placed with potato chips and other chips instead of with the beans, hot sauce and etc.

As set forth above, the plurality of products 20 in the store 18 are typically placed on racks 24 that are placed according to the desired store layout 22 of the particular management of store 18. As is presently done, the various rows 26 and/or aisles 28 in the store 18 will be identified so that the customer 14 and others may be able to reference a particular rack 24 in the store 18. Each rack 24 or pair of racks 24 will be identified by a location indicator 36 that enables a customer 14 to identify where in the store 18 he or she should go to find the desired item 16. As will be readily appreciated by those skilled in the art, location indicators 36 can be virtually any type of indicator that can be used to distinguish one location from another. As shown in FIGS. 1 and 2, the location indicators 36 can be letters (FIG. 1) or numbers (FIG. 2), which are generally preferred due to their ease of use. Alternatively, location indicators 36 can be colors, symbols, figures, shapes, characters or the like. In the configuration of store layouts 22 shown in FIGS. 1 and 2, location indicator 36 is, in effect, a rack indicator that indicates a particular rack 24 or pair of racks 24 in store 18. Although racks 24 are common in most retail stores 18, some stores 18 may not place the plurality of products 20 on racks 24. For instance, a feed store may just have sacks or other containers of feed that define the rows 26 and aisles 28, placing the containers on the floor and eliminating the need for racks 24. Other stores 18 may have some locations in the store 18 that do not use racks 24, such as an area with large sacks of dog food or other bulk items.

Stores 18 commonly position the location or rack indicators 36 over the aisle 28 between rows of racks 24, as shown in FIG. 1, due to the improved visibility of such locations. Typically, these present aisle identifiers include an aisle letter or number and a very short, general list of the products 20 that can be found on the shelves 30 of the racks 24 that bound the aisle 28. As shown in FIG. 3, the present aisle letter or number can be used as the location indicator 36. When placed in aisle 28, the location indicator 36 will reference the pair of racks 24 that bound one aisle 28. As such additional information is required to be utilized with the location indicator 36 to differentiate one rack 24 from another so the customer 14 will know whether the item 16 will be found on rack 24 that is on the left side or the right side of the aisle 28. As set forth in more detail below, the racks 24 also have a plurality of position indicators 38 associated therewith that can be selected so as to provide the necessary differentiation. In FIG. 2, the location indicators 36 are placed above rack 24, at the ends of rows 26 and/or otherwise directly associated with a single rack 24. However, both sides of each rack 24 are utilized to display a plurality of products 20. As discussed below, the position indicators 38 in FIG. 2 are selected to identify the side of the rack 24 where the location of item 16 can be found. As will be readily appreciated by those skilled in the art, the location indicators 36 can be selected so as to designate a single side of a rack 24, thereby allowing each side of a rack 24 to utilize the same position indicators 38. In a preferred embodiment, the location indicators 36 are placed above the rows 26 of racks 24 or aisles 28 so they can be seen throughout the store 18. Alternatively, the location indicators 36 can be placed on the ground, end caps or elsewhere.

As well known in the art, most racks 24 are somewhat long, forming an elongated row 26, and nearly always display more than one type of product (in fact usually having a many different products), thereby requiring use of position indicators 38 to more specifically identify the position on the rack 24 where the item 16 is located. Preferably, as shown in the figures, the position indicator 38 is chosen so as to be somewhat contrasting or otherwise distinguishable from the location indicator 36. For instance, in FIGS. 1 and 3, the location indicators 36 are letters and the position indicators 38 are numbers. FIG. 3 shows rack 24 as having a position indicator of “B” and the position indicators ranging from “12” to “24.” In FIG. 2, the location indicators 36 are numbers and the position indicators are letters. Although position indicators 38 can be numbers (FIGS. 1 and 3) or letters (FIG. 2), which are generally preferred due to familiarity and ease of use, the position indicators 38 can be colors, symbols, figures, shapes, characters or the like. The position indicators 38 need to be placed along the length of each rack 24. They may be placed directly on the rack 24, on signs or the like above the rack 24 or on the floor in front of rack 24.

As set forth above, the racks 24 typically have a plurality of shelves 30 on which the plurality of products 20 are placed that define a plurality of shelf zones 34 (which may be utilized to refer to the space between the shelves 30 or the shelves 30 themselves) where the products 20, including the desired item 16, can be found. As will be readily understood by those skilled in the art, with a set of location indicator 36, position indicator 38 and shelf zone 34, a customer 14 or other person can quickly, easily and efficiently locate a specific item 16 in the store. Depending on the configuration, location indicator 36 will identify the rack 24 or side of rack 24, position indicator 38 will identify the position on the rack 24 and, if required, the side of the rack 24, and shelf zone 34 will identify the shelf 30 or area between shelves 30 where the item is located.

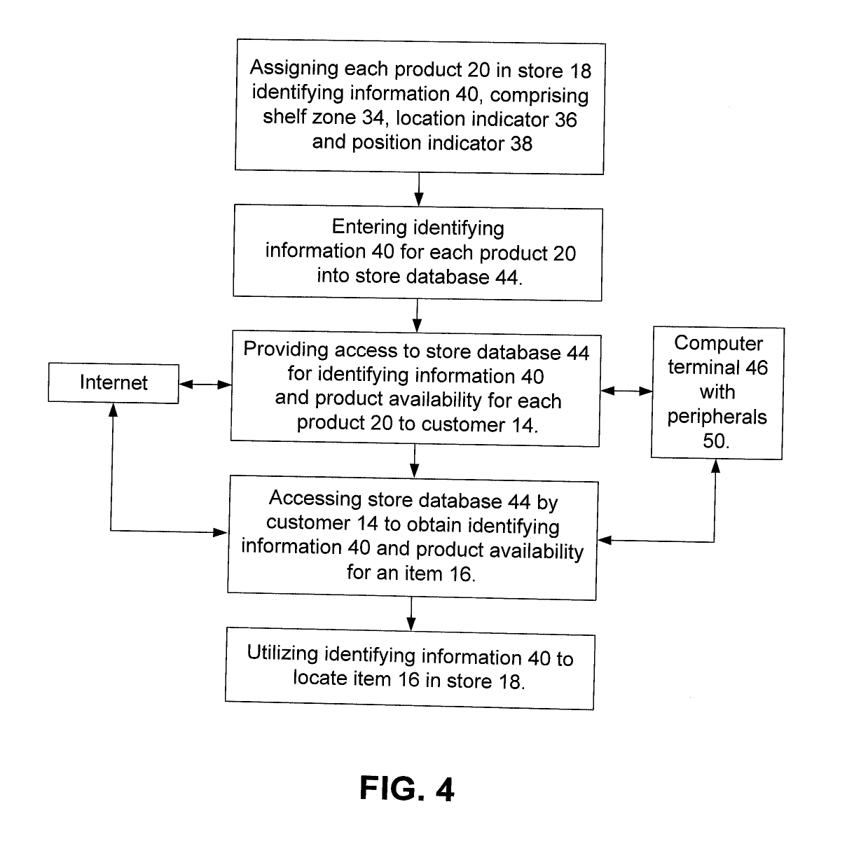

As with the UPC marking for each product in the store, each of the plurality of products 20 will have a location indicator 36, position indicator 38 and shelf zone 34, collectively referred to as identifying information 40 on FIG. 4, associated therewith. As previously indicated, with the identifying information 40 for an item 16 being available, the customer can find the specific item 16 in the store 18. Generally, it will also be beneficial to supply each product with a group number 42, shown in FIG. 3, that is used to identify a product category for each of the plurality of products 20. For instance, a group number 42 can be assigned to fruit juices or, if desired, separate group numbers 42 or sub-category numbers can be assigned to canned fruit juices, bottled fruit juices and fresh fruit juices so the customer 14 can search in the store for “fruit juices” without having to know a specific type of fruit juice that would be associated with specific item 16. A group number 42 can be utilized to designate any type of group, such as brand, type of product or other typical association of products (e.g., Mexican food, Italian food, health/diet food, etc.) that the store manager or other management desires. In some circumstances In this manner, the customer 14 only has to provide a group description and he or she will be directed to one or more locations in the store 18 that are associated with the group number 42. For example, if the customer 14 seeks Mexican food products in a grocery store, as store 18, then he or she will be directed to the locations in the store 18 where the tortilla chips, refried beans, flour/corn tortillas, hot sauce and etc. are located. The customer 14 can go to each of these locations for the products or he or she can select one or more of the group member products that are associated with a group number 42 and go to those locations.

As with the UPC markings, the identifying information 40 and, if utilized, the group number 42 for each of the plurality of products 20 are entered into the store's computerized database 44. As shown in FIGS. 1 and 2, customer 14 will have an access mechanism for accessing database 44, such as directly through a computer terminal 46 and/or the like located in the store 18 or indirectly through a customer device 48 associated with or used by customer 14. The computer terminal 46 in the store 18 should have one or more peripheral devices 50, such as a display screen 52, printer 54 and speaker 56, associated therewith to visually, audibly or electronically provide the identifying information 40 and availability to the customer 14. The customer device 48, which can be a cellular telephone (particularly an iPhone® or other data processing type “smart” phone), PDA, laptop computer, desktop computer or the like, can access store database 44 either from a location that is in the store 18, such as at or generally near the computer terminal 46, and/or through the Internet from a location outside store 18, such as from the home or office of customer 14 or from another convenient location where Internet access is available. In the embodiment where customer 14 accesses the identifying information 40 for an item 16 through the computer terminal 46 in the store 18, he or she can view the identifying information 40 on the screen 52, print it out on a piece of paper by utilizing printer 54 and/or audibly hear identifying information 40 through the speaker 56. If desired, the store layout 22 can also be displayed on screen 52 or printed on printer 54 with the identifying information 40.

Typically, if the customer 14 is seeking only one or a few items 16, he or she will either view the identifying information 40 on the screen 52 or listen to it through the speaker 56. In another embodiment, the computer terminal 46 or kiosk can include the capability to allow the customer 14 to verbally interact with the store database 44. For instance, computer terminal 46 can ask the customer 14 what he or she wants as soon as the customer 14 approaches the computer terminal 46, the customer 14 can speak the desired items and then the identifying information 40 for the items 16 can be broadcast to the customer 14 through the speaker 56. If the customer 14 needs to obtain more than a small number of items 16 and/or is unfamiliar with the store layout 22, then he or she will typically obtain a printed copy of the identifying information 40 for each of the items 16 and a store layout 22 “map” that shows the location of the items 16. Preferably, the computer system programs can be configured such that identifying information 40 for each item 16 from the store database 44 is printed in sequence from one end of the store 18 to the other, with the starting or finishing end being selected by the customer 14, so the customer 14 can efficiently move through store 18 without any backtracking. If desired, pricing information regarding the items 16 and some information regarding related information and/or sale information can also be printed with the location of the items 16 in the store 18.

In another embodiment, customer 14 can access the store database 44 from his or her customer device 48. In a preferred manner of such access, the customer 14 can utilize a hand-held device 48, such as a cellular telephone, PDA or the like, to access store database 44 and electronically transfer the information to the hand-held device 48 so the customer 14 can use the device 48 as he or she walks through the store 18 to obtain the items 16. The customer 14 can transfer the relevant identifying information 40 and product availability for each item 16 to his or her hand-held device 48 via the Internet or by utilizing direct wireless communication to the computer terminal 46 or other computer system in the store 18, such as with the use of an infrared (IR) transmitter, short range RF systems such as the IEEE 802.11 (or Wi-Fi) based radio frequency standard, Bluetooth® or any other available wireless system. If the customer device 48 is a laptop or desktop computer, then the customer 14 can access the store database 44 through the Internet and, if desired, print the identifying information 40 (and store layout 22 if desired) on a printer associated with the customer's computer device 48 or transfer the identifying information 40 and store layout 22 to a hand-held device 48 that the customer 14 can take with him or her to the store 18. In an alternative embodiment, the system 10 and method 12 can be configured to allow the customer 14 to upload a list of items 16 to the store's computing system through the computer terminal 46 so that it may interact with the store database 44 to provide the identifying information 40 for each item on the list. In this manner, the customer 14 can prepare his or her list outside of the store 18 (such as at the home or office) and then upload it at the store 18 to make the shopping more efficient. In yet another embodiment, the store 18 can provide a device 48 to the customer 14 that is specifically configured for use in the store 18 to access store database 44 while he or she is shopping. In this embodiment, the device 48 would be returned to the store 18 at the checkout counter.

In use, persons associated with the store 18 will assign each product 20 in the store 18 identifying information 40, such as its shelf zone 34, location indicator 36 and position indicator 38, that is associated with the location of the product 20 relative to the store layout 22 that can assist the customer 14 with finding a particular item 16 in the store 18. The identifying information 40 for each product 20 is entered into the store database 44, which should already contain UPC and inventory or availability information for each product 20. The store management then provides access to store database 44 to the customers 14 so they may obtain the identifying information 40 and product availability for each of the products 20 in store 18. Typically, the access for the customer 14 will be through a computer terminal 46 that is located in store 18 that has one or more peripherals 50, such as a screen 52, printer 54 and/or speaker 56, associated therewith to provide the identifying information 40 and, if desired, a store layout 22 for an item 16 or items 16 of interest to customer 14. Additionally, access to the store database 44 can be provided, as set forth above, via the Internet or through a customer device 48. When the customer 14 goes to the store 18 seeking one or only a few items 16, he or she will access the store database 44 to obtain the identifying information 40 and, if available, the product availability for each item 16. This identifying information 40, product availability and a store layout 22 can be viewed on the screen 52 by the customer 14, printed on a piece of paper by the printer 54 and/or transferred wirelessly to a customer device 48 that is used by the customer 14 as he moves through store 18 seeking the items 16. Alternatively, the identifying information 40 can be transmitted audibly to the customer 14 through a speaker 56 or the like associated with computer terminal 46. Utilizing the identifying information 40, the customer 14 can easily, quickly and efficiently locate one or more specific items 16 in the store 18. If desired, the system 10 and method 12 could include a mechanism in the store 18, typically located on or near the racks 24, that will cause an audible or visual signal to be activated on the customer device 48 (e.g., a hand-held device such as a “smart” phone or the like) when he or she is in close proximity to the item 16 being sought by the customer 14. The signal can act as an alarm that indicates to the customer 14 he or she is at or near item 16.

The system 10 and method 12 of the present invention benefits customers 14 by allowing them to more efficiently shop for items 16 in a store 18, whether they are familiar with the store 18 or not. Recent remodeling or other moving of products 20 in the store 18 will not be a problem for the customer 14 utilizing the system 10 and method 12. As a result, customers 14 can take advantage of the lower prices and increased selection of a larger store 18, relative to small stores such as convenience stores and the like, without having to be lost in the store 18 or spending too much time seeking only a few items 16 in the large store 18. The stores 18 will benefit by attracting more customers 14 to their store 18, including customers 14 who would have normally gone to a small store and those who do not normally shop at the store 18 but are willing to give it a try with the system 10 and method 12 in place to prevent them from being “lost” in the store 18. In addition to being more customer-friendly, a store 18 will benefit by requiring less employee time to be spent telling customers 14 where items 16 are located and, in some stores 18, physically directing the customer 14 to the items 16. The store 18 may also be able to utilize the system 10 and method 12 for promotional/advertising purposes, for product and/or store survey purposes and to collect more information regarding the searching and purchasing habits of their customers 14.

As stated above, system 10 and method 12 of the present invention are readily adaptable to a wide variety of different types of stores 18, products 20, store layouts 22, shelf arrangements 32, store databases 44, computer terminals 46 and customer devices 48 (among others), as will be understood by those skilled in the art. For instance, the system 10 and method 12 of the present invention are not limited to any particular configuration or store layout 22 for the display apparatuses (e.g., racks 24), such as the parallel or substantially parallel rows 26 shown in FIGS. 1 and 2. The racks 24 or other display apparatuses may be placed in any manner in store 18.

Use of the system 10 and method 12 of the present invention will revolutionize shopping by customers 14 and the way that stores 18 do business by providing customers 14 with a much more efficient manner of shopping and providing stores 18 with an important new tool and significant incentive to better organize the layout 22 of the store 18 in a way that is more conducive to efficient shopping by the customer 14. As described above, the store 18 will be able to more efficiently utilize their employees by significantly reducing the need to help customers 14 with locating items 16 in the store 18. The system 10 and method 12 will substantially reduce or even eliminate the frustration experienced by many customers 14 while shopping for items 16 in a store 18, particularly larger sized stores 18.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A system for locating an item in a store having a plurality of products, wherein the item is one of the products, said system comprising:
one or more display apparatuses in the store, said display apparatuses configured to display the products, including the item, thereon;
a store layout associated with the store and said one or more display apparatuses;
identifying information associated with each of the products in the store, said identifying information identifying the location of each of the products relative to said store layout;
a store database storing said identifying information; and
means utilized by the customer for accessing said store database and obtaining said identifying information for the item so as to locate the item in the store.

2. The system of claim 1, wherein said one or more display apparatuses comprises at least one rack having one or more shelves thereon in a shelf arrangement defining one or more shelf zones, the products, including the item, disposed in said shelf zones.

3. The system of claim 2, wherein said identifying information comprises a location indicator associated with each of said racks, a position indicator associated with the position of the products on said rack and one of said shelf zones.

4. The system of claim 1, wherein said accessing means comprises a computer terminal in the store, said computer terminal configured to transmit said identifying information to the customer.

5. The system of claim 4 further comprising one or more peripheral devices connected to said computer terminal.

6. The system of claim 4, wherein said accessing means further comprises a customer device, said customer device configured to interact with said store database to obtain said identifying information therefrom.

7. The system of claim 6, wherein said customer device interacts wirelessly with said computer terminal.

8. The system of claim 6, wherein said customer device accesses said store database through the Internet.

9. The system of claim 1, wherein said accessing means comprises a customer device configured to interact with said store database to obtain said identifying information therefrom.

10. The system of claim 9, wherein said customer device interacts wirelessly with said store database.

11. A system for locating an item in a store having a plurality of products, wherein the item is one of the products, said system comprising:
one or more racks in the store, each of said racks having one or more shelves configured to display the products, including the item, thereon, said shelves defining one or more shelf zones, the products and the item disposed in said shelf zones;
a store layout associated with the store and each of said racks;
identifying information associated with each of the products in the store, said identifying information identifying the location of each of the products relative to said store layout;
a store database storing said identifying information; and
means utilized by the customer for accessing said store database and obtaining said identifying information for the item so as to locate the item in the store, said accessing means comprising at least one of a computer terminal located in the store and a customer device utilized by the customer.

12. The system of claim 11, wherein said identifying information comprises a location indicator associated with each of said racks, a position indicator associated with the position of the products on said rack and said one of said shelf zones.

13. The system of claim 11, wherein said accessing means comprises said computer terminal, said computer terminal having one or more peripheral devices connected thereto.

14. The system of claim 13, wherein said accessing means further comprises said customer device, said customer device configured to interact wirelessly with said store database to obtain said identifying information therefrom.

15. The system of claim 14, wherein said customer device accesses said store database through the Internet.

16. A method of locating an item sought by a customer in a store having a plurality of products, wherein the item is one of the products, disposed on one or more display apparatuses, said method comprising the steps of:
a) assigning each of said products identifying information, said identifying information identifying the location of each of the products relative to a store layout associated with the store and the display apparatuses;
b) entering said identifying information for each of the products into a store database;
c) providing access to said identifying information in said store database to the customer seeking the item in the store;
d) accessing said store database by the customer to obtain said identifying information for the item; and
e) utilizing the identifying information to locate the item in the store.

17. The method of claim 16, wherein said display apparatuses are racks having shelves defining one or more shelf zones and said identifying information comprises a location indicator associated with each of said racks, a position indicator associated with the position of the products on said rack and said one of said shelf zones.

18. The method of claim 16, wherein said accessing step is accomplished by one of a computer terminal located in the store and a customer device utilized by the customer.

19. The method of claim 16, wherein said accessing step is accomplished by a customer device wirelessly interacting with a computer terminal located in said store to access said store database and obtain said identifying information therefrom.

20. The method of claim 16, wherein said accessing step is accomplished by a customer device accessing said store database through the Internet.
